(19) United States
(12) Patent Application Publication
(10) Pub. No.: US 2004/0002038 A1
(43) Pub. Date: Jan. 1, 2004

(54) Educational magnetic craft kit and method

(76) Inventors: Ann B. Leather, Fitchburg, MA (US); Andrea P. Robinson, Fitchburg, MA (US)

Correspondence Address: ROGER M. RATHBUN, 13 MARGARITA COURT, HILTON HEAD ISLAND, SC, 29926, US

(21) Appl. No.: 10/606,814

(22) Filed: Jun. 26, 2003

Related U.S. Application Data
(63) Continuation of application No. 09/639,529, filed on Aug. 16, 2000, now abandoned.

(51) Int. Cl. G09B 19/00

(52) U.S. Cl. 434/97; 434/96

(57) ABSTRACT

An educational kit for use in teaching children shapes, colors and to exercise creativity. The kit comprises a backboard of a magnetically attractable material, at least one sheet of stencils, at least one sheet of a flexible magnetic material, at least one sheet of a laminating material, coloring implements and a set of graphical instructions. The child can use the stencil sheet to draw a figure or design on to the sheet of magnetic material and then use the coloring implements to color in that design or figure, thus learning shapes as well as colors and coloring techniques. After the design or figure is completed, it can be cut out of the magnetic sheet and laminated by use of the laminating sheets to protect that design or figure. Thus, the completed design or figure can then be affixed magnetically to the backboard so that the child can show off the completed product. As alternative teaching steps, the child can use, or graduate to the use of, freehand figures rather that with the use of the stencils and thus encourage initiative and creativity. As a further alternate, the child can, rather than make the design on to the magnetic material, cut out a picture from a magazine and affix that picture to the magnetic material, laminate the picture along with the magnetic material and use that product to be affixed magnetically to the backboard.

### BACKGROUND OF THE INVENTION

The present invention relates to an educational kit and method of using the same that can be used to teach children creativity as well as to recognize certain colors and shapes of objects by means of a real, visual technique.

There are, of course, considerable number of techniques, devices and kits used in the teaching of children, some of which require the child to assemble, use or adapt a device or graphical representation of certain objects or visual figures or the like in order to get the child to understand and recognize, and ultimately to learn various shapes and colors instilling a sense of creativity in the child. Many of the techniques involve cutting of figures or objects from a pre-printed sheet of such objects and other techniques may involve the actual coloring of those objects so that the child can learn the colors and the skills of applying colors to a configured and well structured outline of that particular shape.

One difficulty with the sole use of structured outlines for the child to color or use, however, is that, while it may instill a sense of creativity as to the coloring aspect, it ignores the creativity of the child actually originating the particular shape itself and therefore is somewhat limiting as a teaching aid. Thus, it would be advantageous to have a teaching or educational kit that would allow the child a certain versatility to enable the child to perceive and work with both colors as well as shapes by allowing the child to exercise creativity as to both aspects.

In addition, it would be advantageous for that educational kit to allow the child to grow in the creativity aspect, that is, so that the child who is not quite ready to assume total creativity in the creation of free lance shapes, can, instead, use conventional printed or configured shapes initially in order to lead the child, through the use of the same educational kit, onward in the learning process to the creation of th child's own shapes.

In addition it would be a further advantage for the educational kit to provide a means of displaying the creative article produced by the child as to allow the parent or others, as well as the child, to easily place the article produced by the child in a location where it can be viewed by others and a convenient display means would include th use of a backboard having a magnetically attractable surface to which that the child's creation can be readily affixed for for the display of that creation.

As examples of current apparatus and/or devices for creation and display of articles, there is shown in U.S. Pat. No. 4,846,689 of Day a figure representing an animate object, such as a child, and the child is encouraged to place objects onto the figure that are then affixed to the figure by a magnetic attraction. Thus, the child can select certain objects that conform to the overall configuration of the animate object and attach those objects to the figure. Examples of the object may be clothing, geometric figures and the like. The object of the Day educational kit is said to be to teach the child basic concepts of color, time, identification, shapes, counting and the like.

However, in the Day educational kit, the child uses preformed or pre-configured shapes for the animate figure and the objects to be added to that figure are also preconfigured and provided with the teaching aid and, therefore, the teaching aid of Day does not allow the child to exercise the creativity of basically free lance creation by the child of the objects or other shapes. Thus, while a useful tool for teaching, by providing all of the necessary item as pre-shaped figures and objects, the child does not get to make original creations of those objects themselves and a part of the teaching of individual creativity is missing.

Next, in U.S. Pat. No. 4,353,700 of Volakakis, there is a educational learning aid that again teaches conformity by providing a plastic cover that has opening that conforms to certain objects to be placed in that cover by the child. As examples, th child may, by use of the Volakakis learning aid, be taught the alphabet, numbers and the like and th separate pieces can be magnetized to cause the individual numbers of letters to adhere to the backing so that the child can progressively add the individual letters or numbers to the learning aid. Again, while the learning aid of Volakakis may be useful to teach a child certain prescribed sequences of letters or numbers, it does not bring out the individual creativity of the child. In fact, the very purpose of the Volakakis learning aid is to discourage individual creativity since the learning aid is teaching the child to conform to a certain desired sequence of numbers or letters, i.e. to learn the alphabet and, obviously, individual creativity is not a desirable attribute of a child trying to learn the alphabet.

There are also other examples of the use of a magnetic backing for the display of a design for differing purpose, i.e. not for a educational kit or instructional use for a child and thus are of interest as uses of a magnetic surface as a display means, however, such examples are not particularly applicable to a educational program for children. For instance, in U.S. Pat. No. 5,666,712 of Cvetkov, there is a magnetic surface that is specially created by the use of a magnetic paint that can be applied to a surface where a magnetic part having a two-dimensional or three dimensional form can be affixed to that magn tic painted surface. In the Cvetkov patent, however, there is a reference to the children creating a variety of such two and three dimensional objects from precut pieces and then photographing the designs to thereafter display the photographs on the magnetically attractable paint that has been applied to the particular display surface. In any event, while usable by children, the Cvetkov patent is not directed to a educational program or kit that can be supplied for the use of children to teach colors and shapes while actively promoting the individual creativity of the child.

As another example of a decorative design applied to a magnetic display board, but again irrelevant to an educational kit for children, there is U.S. Pat. No. 4,835,024 of Halley that is another use of precut figures or designs that can be affixed to a magnetized base with an interconnection member that can accept a variety of differing designs. Thus, again, while there is the use of a magnetic board or sheet of material as a means of displaying decorative items, the article of Halley appears to be limited to the use of precut decorative articls that are genrally suggested as being applicable to an automobile exterior to nhance th appearance of that automobil.

Finally, in the Weinhaus, U.S. Pat. No. 4,287,676, there is a magnetic display apparatus that utilizes an lastomeric material to achieve a good adherence or affixation to a magnetically attractable material for a variety of purposes and is thus not related to or relevant to an educational kit used as an learning aid for children to teach color, shapes and, at the same time, encourage individual creativity.

Accordingly, as can be seen, while there may be a number of educational learning kits described in the prior art, none, singly, or combined, would afford an opportunity for the child to grow educationally from a more rigid structure in the inception and display of the various creations to a more liberal, free lance creation of such designs where the child can exercise more creativity in the use of designs and colors so as to progress the artistic education of the child.

### SUMMARY OF THE INVENTION

The present invention provides an improved kit for children's education and which allows a teaching program to be administered to such children and to allow the child to learn not only basic shapes, colors and the like, but also to encourage freelance initiative and creativity in the child.

In the present kit, therefore, there are various components that carry out the aforesaid purpose and which include a backboard that has a surface that is comprised of a magnetically attractable material. The kit also contains one or more stencil sheets, preferable sheets of normal letterhead size paper for the stencil sheets, i.e. 8½ by 11 inch sheets of stencils. The stencil sheets may include any number of differing shapes that can be selected by the child and which can include animals, insects, figures, fish or a whole host of other designs and figures that would be pleasing to a child to use.

In addition to the stencil sheets, the educational kit includes one or more sheets of a rubber material having a magnetic material such that the magnetic sheets can be readily affixed by magnetic attraction to th backboard as desired by the child or the supervisor.

Further the educational kit of the present invention includes a plurality of colored pencils, pens or other coloring implements to enable the child to color in a design that is made on, or to be affixed to, one of the magnetic sheets. By this manner, the child can, with the use of the contents of the present educational kit, use the stencil sheets to draw a wide variety of shapes and designs on to the magnetic sheets and cut out the design for mounting, magnetically, to the backboard for display to others.

In such an exercise, the magnetic sheet material may have one side that is white or other suitable color that allows the child to draw directly on the surface of the magnetic material or a suitable surfaced sheet of material may be affixed to one side of the magnetic material to allow such drawing to take place. As the design is formed on the magnetic sheet, the colored pencils can also be used by the child to color the object as desired and thus, the child not only is educated in the basic shapes of the objects but also the use in the use of color to enhance the display of that object.

As an alternative embodiment, the sheet or sheets of magnetic material may have one side comprised of a sticky surface, rather that a surface to be used for drawing ujpon, such that the pictures of other graphic indicia may readily be affixed to the sticky surface. If the sticky surface embodiment is present, there may be additionally be provided a film of protective material that initially covers the sticky surface to allow the magnetic sheet to be readily handled without adhering to foreign objects and the protective film can be removed as desired by the user when at the time that the graphical picture of other design is desired to be affixed to that sticky surface.

As a feature of the present educational kit, therefore, the child can follow or use the stencils as a guide to produce a shape, design or figure, however, with the use of the magnetic sheets, the child is also free to exercise total creativity and to free hand an object or design on to the magnetic sheets without the use of stencils. Thus, in progressing the development of the child, initially the child can be instructed to use the stencils to draw the particular figure or dsign and, after the child has gained proficincy and confidnce in th u of stencils, th child can be waned away from th use of stencils and be encouraged to produce original designs and figures to stimulate th creativity in the child. Accordingly, with the present educational kit, the child can learn not only shapes and colors, but additionally, the kit can be used to stimulate a creativ nature in the child to design and color original shapes and figures.

As a further component of the present educational kit, there are a plurality of laminated plastic sheets, again preferably about 8½ by 11 inch size, and which allow the child to laminate the particular final colored design or figure to preserve that article for mounting upon the backboard.

Finally, there is a set of instructions for the adult, or to an older child, to instruct that person in the use of the kit, that is, in the stenciling, the coloring of the surface of the magnetic sheets of a design or figure drawn on the magnetic sheets and in the lamination process so that the user can properly carry out those functions in the use of the educational kit. The set of instructions may be separately comprised of a sheet or shets of graphical instructional material or, alternatively, may be imprinted on the packaging such as the box, containing the components of the educational kit herein described.

As can be seen, therefore, with the present educational kit, the child can basically be taught certain shapes and to recognize those shapes, can learn the use of proper colors by coloring the selected shapes and can carry out the lamination of the final d sign or figure for eventual mounting on a backboard by means of a magnetic attraction between the magnetically attractable surface of the backboard and the magnetic sheet material. In addition, in order in order to instill a sense of creativity in the child, the child can be encouraged to discontinue the use of the stencils so as to exercise creativity by crafting an original design or figure on to the magnetic sheets and, after lamination, can display that original design on the backboard.

Other features of the present educational kit will become apparent in light of the following detailed description of a preferred embodiment thereof and as illustrated in the accompanying drawings.

### BRIEF DESCRIPTION OF THE DRAWINGS

FIG. 1 is a front view of th backboard componnt of the present educational kit;

FIG. 2 is front view of but a variety of figures and designs that are contemplated to be constructed using the present educational kit;

FIG. 3 is a front view of a typical stencil sheet used with the present invention;

FIG. 4 is a front view of a typical magnetic sheet incorporated into the present invention;

FIG. 5 is a front view of coloring implements contained within the present educational kit;

FIG. 6 is a front view of a typical laminated plastic sheet used with the present invention; and

FIG. 7 is a front view of the instructional material that is included as a component of the present educational kit.

### DETAILED DESCRIPTION OF THE INVENTION

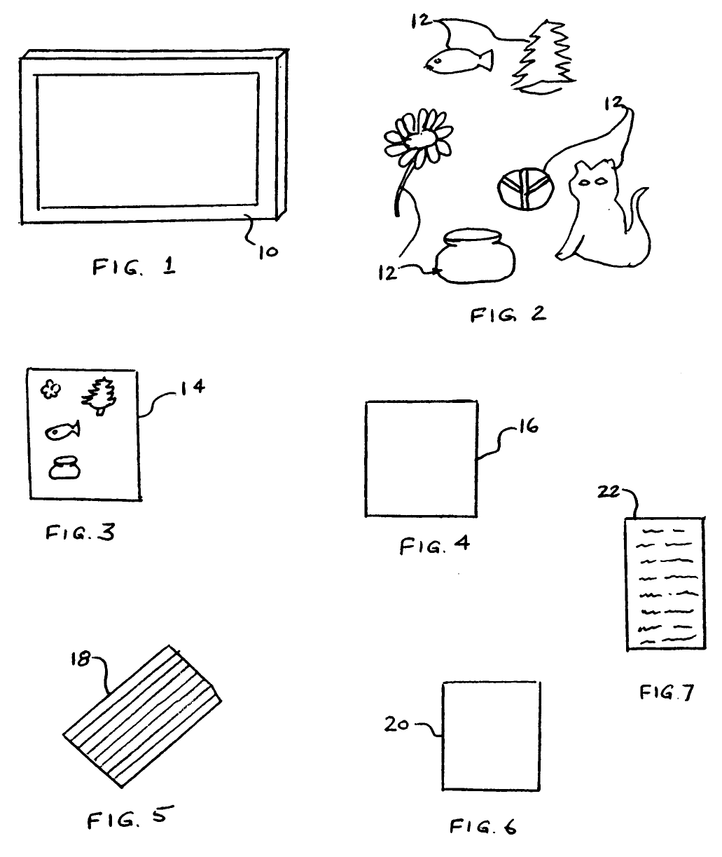

Referring now to FIG. 1, there is shown a front view of a backboard 10 that is used with the present invention and which has a surface that is comprised of a magnetically attractable material, that is, that a permanent magnet material can be readily affixed to the surface of the backboard 10 to be displayed thereon and retained thereon by magnetic attraction. In the preferred embodiment, the backboard 10 is of a sufficiently small size so as to be readily made and incorporated into a kit for sale commercially but large enough to effectively constitute a prominent display for the child's creation produced by means of the presnt invntion. A preferred size is a rectangular backboard 10 having dimensions of about 24 inchs high by 30 inchs in length.

Turning now to FIG. 2, there is shown a front view of som of the possibl designs of objcts 12 such as figures or attractive shaps that can be used with the present invention and which are attractive to children and thus make up a wide variety of composite or individual objects 12 to be produced by the children by means of the present invention. As can be seen, the objects 12 may include animals, fish, flowers, and the like and are only illustrative of typical objects 12 that can be produced as may be desired by the child. Obviously, the variety of such objects 12 is virtually unlimited and can be produced as desired or believed to be suitable and attractive to children.

In FIG. 3, there is shown a front view of a typical stencil sheet 14 that can be used to produce the objects 12 of FIG. 2 and, again, the number and shapes and sizes of the openings in the stencil sheets in the stencil sheet 14 is unlimited and can be any designs or figures that would appeal to a child to produce an object 12 for eventual display. Again, in the preferred embodiment, the stencil sheets 14 can be 8½ by 11 inches in dimensions so as to be compatible with other components of the present educational kit and to be delivered and packaged in kit form to carry out the intent of this invention. Obviously, there may be one or a plurality of such stencil sheets 14 provided with the educational kit.

Turning now to FIG. 4, there is shown a front view of a magnetic sheet 16 that is provided as a component of the present educational kit and the magnetic sheet 16 can be a rubber based, flexible material having a magnetic material incorporated therein and such material is commercial available. It is, of course, preferred that one surface of th magnetic sheet 16 be a light color, preferably white, so that a design can be drawn on the magnetic sheet 16 as will become clear in the use of the present educational kit. Again, in the preferred embodiment, the magnetic sheet 16 is 8½ by 11 inches in dimensions and, of course, a plurality of such magnetic sheets 16 can be supplied along with an educational kit in carrying out the present invention. Alternatively, one side of the magnetic material may comprise s sticky surface in order to enable the user to affix a drawing thereto to accomplish the same purpose as having one side of the magn tic material of a sufficiently light color so as to allow the child to draw directly thereon. Again, as indicated, if the one surface is comprised of a sticky material, there may also be a film that initially covrs that sticky surface to enable the user to handle the material without having it adhere to some undesirabl item and th protective film removed when the child's creation has been complted and that creation is desired to be affixed to that sticky surface.

In FIG. 5, there is a front view of coloring implements 18 that are supplied as a component of the present educational kit, and those coloring implements may be color pencils, color pens or any other implements that can be used to color a design made by a child with the present educational kit Certainly, a variety of colors is needed so that the child can have a selection of many colors in order to teach the child the various colors that are used with any particular figure or design in order to learn compatible colors for the figure or design.

Next, in FIG. 6, there is a front view of a laminated plastic sheet 20 that is also a component of the present educational kit and, again, in the preferred embodiment, the laminated plastic sheets 20 are 8½ by 11 inches in dimensions to fit with the other component of the kit and the laminated plastic sheet or sheets 20 have an adhesive backing that can be used to enclose a product produced by means of the present educational kit to protect that product and to adhere to the product formed from the magnetic sheet 18 of material. The laminated plastic sheets 20 are, of course, cut to size depending upon the particular design or figure produced by the child.

Finally, there is shown in FIG. 7 an instruction sheet 22 having the detailed instructions to enable the older child, or an adult assisting or instructing a younger child, in the use of the educational kit and may include the application of the stencils to draw a figure or design on to the magnetic sheets, the application of the colors and the laminating step the eventual design or figure to enable that person to be able to produce a design or figure by use of the present educational kit. As noted, the instruction sheet 22 may b a separate item included in the education al kit or, alternatively, may be imprinted on a part of the packaging of the educational kit, such as by printing the instructions on th box within which th individual components are packaged for commercial distribution.

It can now be seen that the method or procedure for using the educational kit of the present invention can now be explained. Initially as a step, the stencil sheet 14 is used to draw a design or figure on to th magnetic sheet 18 so that the child can produce any one of a vast variety of design or figures, limited only by the number of such figures or designs available in the stencil sheet 14. In carrying out the method, therefore, the magnetically attractable backboard 10 is provided as well as the stencil sheets 14, the magnetic sheets 16, the coloring implements 18, the laminating sheets 20 and the instructions 22. The stencil sheets 14 can be used by the child to make an outline of a figure of design onto the magnetic sheets 16 so that the outer line sketch appears. Alternatively, as explained, the child can be encouraged to exercise individual initiative and creativity by freehanding a design or figure onto the magnetic sheets 16. Thus, as a progressive learning technique, the child may be started on the stencils until the confidence and skill improves to the point where the child is ready and wants to progress to the creation of original figures or designs and thus, the artistic creation is stimulated in the child.

When the outline is complete, the coloring implements 18 are used to color in th design or figure and, again, the child can learn the complementary colors as well as the appropriate colors for the figures. Once colored, in further carrying out the inventive method, the particular design or figure is cut out of the magnetic sheets 18 and laminated with the laminating sheets 20 to protect the design or figure and to enable it to be magnetically affixed to the magnetic backboard 10. As a further alternative, in the event the child is not interested, or resists the use of the stencil sheets 14, the child can go directly to the laminating step and cut out pictures from a magazine, place that cut-out on the magnetic sheet 18 and have that item laminated, thus the child has the versatility with the present educational kit to memorialize favorite pictures from magazines such as favorite movie stars, animals and the like.

It will be understood that the scope of the invention is not limited to the particular embodiment disclosed hrein, by way of example, but only by th scop of the appended claims.

I claim:

1. An educational kit for promoting learning and creativity in children, said educational kit comprising:
a backboard having a surface comprised of a magnetically attractable material,
at least one stencil sheet,
at least one sheet of a flexible magnetic material,
a plurality of coloring implements of differing colors,
at least one sheet of a laminating material, and
a graphical instruction sheet.

2. An educational kit as defined in claim 1 wherein said at least one stencil sheet, said at least one sheet of flexible magnetic material, said plurality of coloring implements and said at least one sheet of a laminating material are contained within a package and said graphical instruction sheet is imprinted directly on said package.

3. An educational kit as defined in claim 1 wherein said at least one stncil sheet, said at least one sheet of flexible magnetic material and said at least on sheet of a laminating material comprises a plurality of said sheets of stencil sheets, flexible magnetic material and laminating materials.

4. An educational kit as defined in claim 3 wherein said plurality of sheets of stencil sheets, flexible material and laminating material are all about the same dimensions.

5. An educational kit as defined in claim 1 wherein said at least one sheet of flexible magnetic material has one surface of a light color to enable a graphical design to be directly created on said light surface.

6. An educational kit as defined in claim 1 wherein said at least on sheet of flexible magnetic material has one surface comprised of a sticky material to enable a separate sheet having a creation to be affixed thereto.

7. A method of providing education to a child comprising the steps of:
providing a backboard having a surface comprised of a magnetically attractable material,
providing at least one sheet of stencils,
providing at least one sheet of a flexible magnetic material,
providing coloring implements,
providing at least one sheet of a laminating material,
creating a design or figure on the sheet of flexible magnetic material,
coloring the design or figure by using the coloring implements,
laminating the design or figure made on the sheet of magnetic material in the laminating material, and
affixing the laminated figure or design by magnetic attraction on to the backboard.

8. A method of providing education to a child as defined in claim 7 wherein said step of creating a design or figure on the at least one sheet of magnetic material comprises affixing a design or figure to said at least one sheet of magnetic material

9. A method of providing education to a child as defined in claim 8 wherein said step of providing at least one sheet of a flexible magnetic material comprises providing at least one sheet of flexible magnetic material having a sticky surface.

10. A method of providing education to a child as defined in claim 7 wherein said step of providing at least one sheet of stencils, said step of providing at least one sheet of a flexible magnetic material and said step of providing at least one sheet of a laminating material comprises providing a plurality of said sheets of stencils, a plurality of said sheets of flxible magnetic material and a plurality of said sheets of said laminating matrial.

11. A method of providing education to a child as defined in claim 10 wherein said steps of providing a plurality of sheets of stencils, a plurality of sheets of flexible magnetic material and a plurality of sheets of laminating matrial compris providing said components of substantially uniform dimensions to enable said components to be packaged together.

12. A method of providing education to a child as defined in claim 7 wherein said step of providing a backboard comprises providing a separate backboard along with said other components in a common package.

13. An educational kit for promoting learning and creativity in children, said educational kit comprising:
at least one stencil sheet,
at least one sheet of a flexible magnetic material,
a plurality of coloring implements of differing colors,
at least one sheet of a laminating material, and
a graphical instruction sheet.

14. An educational kit as defined in claim 13 wherein said at least one stencil sheet, said at least one sheet of flexible magnetic material, said plurality of coloring implements and said at least one sheet of a laminating material are contained within a package and said graphical instruction sheet is imprinted directly on said package.

15. An educational kit as defined in claim 13 wherein said at least one stencil sheet, said at least one sheet of flexible magnetic material and said at least on sheet of a laminating material comprises a plurality of said sheets of stencil sheets, flexible magnetic material and laminating materials.

16. An educational kit as defined in claim 15 wherein said plurality of sheets of stencil sheets, flxible material and laminating material are all about the same dimensions.

17. An educational kit as d fined in claim 13 wherein said at last one sheet of flexible magnetic material has one surface of a light color to enable a graphical design to be directly created on said light surface.
